(19) United States
(12) Patent Application Publication
(10) Pub. No.: US 2026/0177502 A1
(43) Pub. Date: Jun. 25, 2026

(54) ULTRA-HIGH SENSITIVITY HYBRID INSPECTION WITH FULL WAFER COVERAGE CAPABILITY WITH STEP AND SETTLE STAGE

(71) Applicant: KLA Corporation, Milpitas, CA (US)

(72) Inventors: John Gerling, Livermore, CA (US); Lawrence P. Muray, Milpitas, CA (US); Naga Chennuri, Milpitas, CA (US)

(21) Appl. No.: 18/999,512

(22) Filed: Dec. 23, 2024

(51) Int. Cl. G01N 21/88; G01N 21/17; G01N 21/47; G01N 21/95

(52) U.S. Cl. CPC G01N 21/8851; G01N 21/47; G01N 21/9505; G01N 2021/1765; G01N 2021/4735; G01N 2021/8867; G01N 2201/103

(57) ABSTRACT

A hybrid inspection system comprising is disclosed. The hybrid inspection system includes an optical inspection tool configured to identify candidate defects on a sample by directing an illumination beam to the sample with light and collecting scattered light from the sample in response to the illumination beam. The hybrid inspection system includes a multi-column inspection tool to identify defects of interest from the candidate defects, wherein the multi-column inspection tool comprises: two or more columns to simultaneously image two or more measurement regions on the sample and a translation stage configured to secure and position the sample with respect to the two or more columns, wherein the translation stage is configured to image at least a portion of the candidate defects using a step-and-settle sampling plan.

### TECHNICAL FIELD

The present disclosure relates generally to defect detection and, more particularly, to defect detection through hybrid inspection.

### BACKGROUND

Generally, the industry of semiconductor manufacturing involves highly complex techniques for fabricating integrated circuits using semiconductor materials which are layered and patterned onto a substrate, such as silicon. Due to the large scale of circuit integration and the decreasing size of semiconductor devices, the fabricated devices have become increasingly sensitive to defects. That is, defects which cause faults in the device are becoming increasingly smaller. The device needs to be generally fault free prior to shipment to the end users or customers.

Defect detection is generally implemented across a full wafer for yield management in the semiconductor manufacturing industry. Types of defects, counts of defects, and signatures found by inspection systems (or inspectors) provide valuable information for semiconductor fabrication to ensure that the manufacturing process established in the research and development phase can ramp, that the process window confirmed in the ramp phase can be transferrable to high volume manufacturing (HVM), and that day-to-day operations in HVM are stable and under-control.

An optical inspector is currently the only viable platform in the market to deliver enough speed to economically yield full wafer inspection. Full wafer coverage with an optical inspector has been implemented for HVM due to low expected defect counts on the wafer. In a mature process, the expected defect counts are typically less than 1000. Because of these low counts, combined with the mostly random locations of the defects across a 300 mm wafer, full wafer coverage with an optical inspector has been historically used to monitor the HVM process.

However, optical scanning of samples alone may not provide sufficient sensitivity to detect certain defects and high-resolution scanning systems lack sufficient throughput to make their use efficient.

As design rule shrinks, however, the sensitivity gap between what is required for defect monitoring and what can be provided by optical inspector widens. This sensitivity gap is caused by the increasing disparity between critical dimension (CD) length and optical point spread function (PSF) size. As a result, an optical inspector is not able to differentiate certain defect signals from nuisance signals, which reduces optical inspector's ability to cleanly detect DOI's. Thus, current inspection systems and methodologies have a high sensitivity defect detection performance gap.

Accordingly, it is desirable to develop systems and methods to address these demands.

### SUMMARY

A hybrid inspection system is disclosed, in accordance with one or more embodiments of the present disclosure. In embodiments, the hybrid inspection system includes an optical inspection tool configured to identify candidate defects on a sample by directing an illumination beam to the sample with light and collecting scattered light from the sample in response to the illumination beam. In embodiments, the hybrid inspection system includes a multi-column inspection tool to identify defects of interest from the candidate defects. In embodiments, the multi-column inspection tool includes two or more columns to simultaneously image two or more measurement regions on the sample. In embodiments, the hybrid inspection system includes a translation stage configured to secure and position the sample with respect to the two or more columns, wherein the translation stage is configured to position the sample to allow the two or more columns to image at least a portion of the candidate defects using a step-and-settle sampling plan. In embodiments, the hybrid inspection system includes a controller including one or more processors configured to execute program instructions and the step-and-settle sampling plan. In embodiments, the step-and-settle sampling plan causes the one or more processors to generate parallel images of the sample with the two or more columns. In embodiments, the step-and-settle sampling plan causes the one or more processors to translate the sample by a step size with the translation stage. In embodiments, the step-and-settle sampling plan causes the one or more processors to wait a settling time required for vibrations of the translation stage to settle below a selected tolerance. In embodiments, the step-and-settle sampling plan causes the one or more processors to generate additional parallel images of the sample with two or more columns.

A hybrid inspection method is disclosed, in accordance with one or more embodiments of the present disclosure. In embodiments, the hybrid inspection method includes identifying candidate defects on a sample with an optical inspection tool configured to identify by directing an illumination beam to the sample with light and collecting scattered light from the sample in response to the illumination beam. In embodiments, the hybrid inspection method includes imaging at least a portion of the candidate defects with a multi-column inspection tool. In embodiments, the multi-column inspection tool includes two or more columns to simultaneously image two or more measurement regions on the sample. In embodiments, the multi-column inspection tool includes a translation stage configured to secure and position the sample with respect to the two or more columns, wherein the translation stage is configured to position the sample to allow the two or more columns to image at least a portion of the candidate defects using a step-and-settle sampling plan. In embodiments, the step-and-settle sampling plan includes generating parallel images of the sample with the two or more columns. In embodiments, the step-and-settle sampling plan includes translating the sample by a step size. In embodiments, the step-and-settle sampling plan includes waiting a settling time required for vibrations of the translation stage to settle below a selected tolerance. In embodiments, the step-and-settle sampling plan includes generating additional parallel images of the sample with two or more columns. In embodiments, the hybrid inspection method includes identifying defects of interest from the candidate defects based on the images of the sample from the multi-column inspection tool.

A hybrid inspection system is disclosed, in accordance with one or more embodiments of the present disclosure. In embodiments, the hybrid inspection system includes an optical inspection tool configured to identify candidate defects on a sample by directing an illumination beam to the sample with light and collecting scattered light from the sample in response to the illumination beam. In embodiments, the hybrid inspection system includes a multi-column inspection tool to identify defects of interest from the candidate defects. In embodiments, the multi-column inspection tool includes two or more columns to simultaneously image two or more measurement regions on the sample. In embodiments, the hybrid inspection system includes a translation stage configured to secure and position the sample with respect to the two or more columns, wherein the translation stage is configured to position the sample to allow the two or more columns to image at least a portion of the candidate defects using either a step-and-settle sampling plan or a swathing sampling plan. In embodiments, the hybrid inspection system includes a controller including one or more processors configured to execute program instructions and the step-and-settle sampling plan. In embodiments, the step-and-settle sampling plan causes the one or more processors to generate parallel images of the sample with the two or more columns. In embodiments, the step-and-settle sampling plan causes the one or more processors to translate the sample by a step size with the translation stage. In embodiments, the step-and-settle sampling plan causes the one or more processors to wait a settling time required for vibrations of the translation stage to settle below a selected tolerance. In embodiments, the step-and-settle sampling plan causes the one or more processors to generate additional parallel images of the sample with two or more columns. In embodiments, the swathing sampling plan causes the one or more processors to generate parallel images of the sample with the two or more measurement columns while the sample is in motion.

### BRIEF DESCRIPTION OF THE DRAWINGS

The detailed description is described with reference to the accompanying figures. The use of the same reference numbers in different instances in the description and the figures may indicate similar or identical items. Various embodiments or examples (“examples”) of the present disclosure are disclosed in the following detailed description and the accompanying drawings. The drawings are not necessarily to scale. In general, operations of disclosed processes may be performed in an arbitrary order, unless otherwise provided in the claims. In the drawings:

FIG. 1 illustrates a block diagram illustrating a hybrid inspection system, in accordance with one or more embodiments of the present disclosure.

FIG. 2A illustrates a first phase of hybrid inspection, in accordance with one or more embodiments of the present disclosure.

FIG. 2B illustrates results of the first phase of hybrid inspection, in accordance with one or more embodiments of the present disclosure.

FIG. 2C illustrates a second phase of hybrid inspection and associated results, in accordance with one or more embodiments of the present disclosure.

FIG. 3A illustrates an array of columns in the multi-column inspection tool, in accordance with one or more embodiments of the present disclosure.

FIG. 3B illustrates a schematic view of step-and-settle sampling plan for a single column, in accordance with one or more embodiments of the present disclosure.

FIG. 3C illustrates a schematic view of swathing sampling plan for a single column, in accordance with one or more embodiments of the present disclosure.

FIG. 4A illustrates a flow diagram illustrating a step-and-settle sampling plan, in accordance with one or more embodiments of the present disclosure.

FIG. 4B illustrates a flow diagram illustrating a swathing sampling plan, in accordance with one or more embodiments of the present disclosure.

FIG. 5 illustrates a flow diagram illustrating a method for hybrid inspection, in accordance with one or more embodiments of the present disclosure.

FIG. 6A illustrates a plot illustrating a random uniform distribution of points, in accordance with one or more embodiments of the present disclosure.

FIG. 6B illustrates a subdivision of the plot in FIG. 6A, in accordance with one or more embodiments of the present disclosure.

FIG. 6C illustrates a chart showing the number of points in each subdivision, in accordance with one or more embodiments of the present disclosure.

FIG. 7A illustrates a plot of candidates for a scan with the optical inspection tool, in accordance with one or more embodiments of the present disclosure.

FIG. 7B illustrates a plot of common candidates between columns of the multi-column inspection tool.

FIG. 7C illustrates plots of common candidate placement for various spacings, in accordance with one or more embodiments of the present disclosure.

FIG. 8 illustrates a simplified schematic view of a column of a multi-column inspection tool, in accordance with one or more embodiments of the present disclosure.

FIG. 9 illustrates a simplified schematic view of an optical inspection tool, in accordance with one or more embodiments of the present disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

Embodiments of the present disclosure are directed to systems and methods providing hybrid defect inspection using a first pass with an optical inspection system and at least a second pass with a multi-column high-resolution inspection system, where the multi-column high-resolution inspection system implements a step-and-settle sampling plan developed from results from the first pass for efficient operation.

In embodiments, a hybrid inspection system includes an optical inspection tool and a multi-column inspection tool providing a higher resolution than the optical inspection tool, where the optical inspection tool performs a first inspection pass to identify candidate defects that may be reviewed by the multi-column inspection tool in one or more subsequent passes. An aggressive threshold may be set for the optical inspection to enable a sensitivity of under 10 nm so that defects of interest (DOIs) may be detected in the optical scans and later identified by the multi-column inspection tool. An aggressive threshold for the optical inspector is selected to likely result in 5-20 million candidate defect sites from the first phase of inspection.

Such a hybrid inspection system may benefit from a high throughput provided by the optical inspection tool as well as a high resolution provided by the multi-column inspection tool to provide both fast and accurate defect inspection. In particular, utilizing the multi-column inspection tool to analyze candidate defects identified by the optical inspection tool may be substantially faster than inspecting an entirety of the sample with the multi-column inspection tool. A hybrid inspection system in which a second-pass inspection tool performs inspection while a sample is in motion, referred to herein as a swathing sample plan, is generally described in U.S. Pat. No. 10,545,099 issued on Jan. 28, 2020, which is incorporated herein by reference in its entirety.

However, the performance and/or cost of ownership associated with multi-pass defect inspection may depend on a variety of factors including, but not limited to, an achievable throughput during operation and the initial component costs.

It is contemplated herein that employing a step-and-settle sampling plan with a multi-column inspection tool of a hybrid inspection system as disclosed herein may enable both high performance lower cost of ownership than existing systems. For example, a step-and-settle sampling approach may be implemented with relaxed synchronization requirements between a translation stage and measurement equipment, at least compared to a swathing approach. As a result, a step-and-settle sampling approach may be implemented with relatively lower-cost equipment. As another example, a step-and-settle sampling approach may provide substantial flexibility to adjust a sampling plan to provide efficient operation based on a wide range of parameters including, but not limited to, a per-sample inspection time limit or mechanical limitations of a translation stage. As an illustration, a step-and-settle sampling plan may provide an adjustable step distance between any successive measurements.

In some embodiments, a step-and-settle sampling plan for a multi-column tool is generated based on a set of candidate defects from the optical inspection tool and optionally additional constraints such as, but not limited to, a desired per-sample measurement throughput, mechanical limitations of a translation stage, or the like. For example, the step distances between successive measurements may be selected to provide at least one candidate defect identified by the optical inspection tool is within an accessible measurement field of view for each column of the multi-column inspection tool to ensure efficient operation. As another example, the step distances between successive measurements may be selected at least in part based on the time required for a translation stage to move and settle. In a general sense, a step-and-settle sampling plan may be optimized to provide a desired balance of measurements performed and overall throughput based on any considerations or limitations.

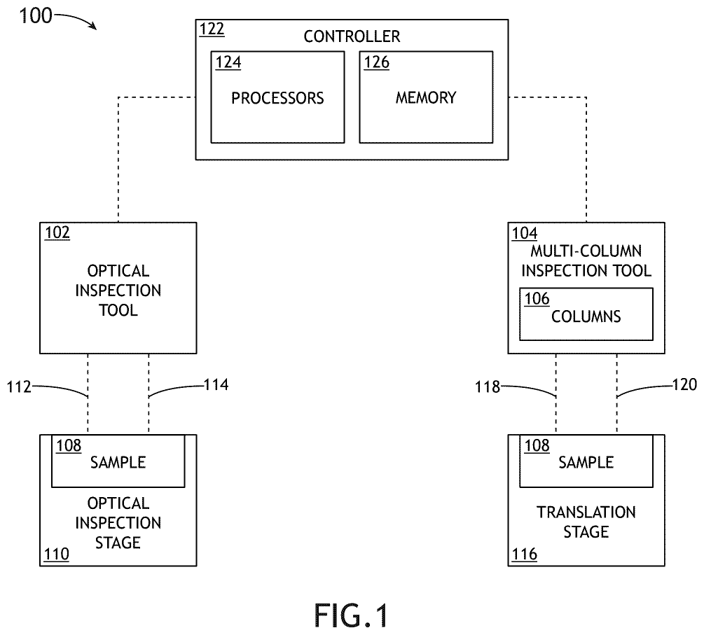

FIG. 1 illustrates a block diagram illustrating a hybrid inspection system 100, in accordance with one or more embodiments of the present disclosure.

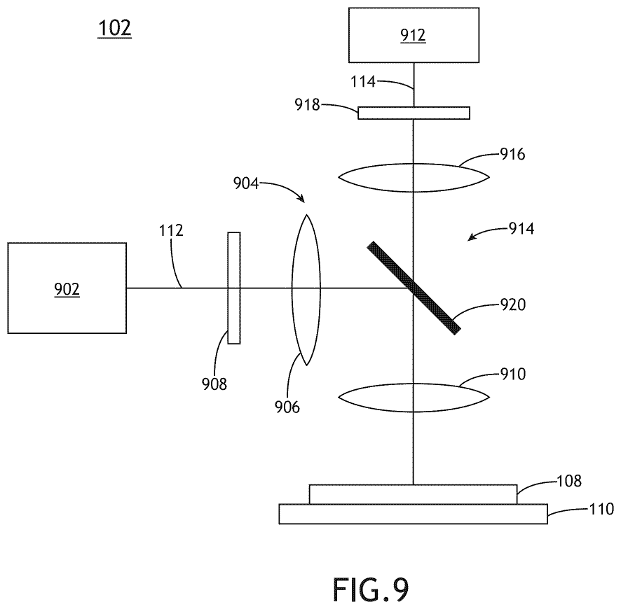

In embodiments, the hybrid inspection system 100 includes an optical inspection tool 102. The optical inspection tool 102 may include any suitable optical inspection tool in the art. The optical inspection tool is discussed in more detail with reference to FIG. 9.

In embodiments, the hybrid inspection system 100 includes a multi-column inspection tool 104. The multi-column inspection tool 104 may include a set of columns 106 (e.g., two or more columns 106). The multi-column inspection tool 104 and columns 106 may include any suitable multi-column inspection tool in the art. The multi-column inspection tool 104 and columns 106 are discussed in more detail with reference to FIG. 10.

In embodiments, the optical inspection tool 102 and the multi-column inspection tool 104 are configured to scan a sample 108. As used herein, scan or scanning means implementing a sampling plan to characterize, or inspect, some, or all, of the sample 108.

For example, the optical inspection tool 102 may be configured to perform a first scan on the sample 108 (e.g., the first phase of hybrid inspection). In embodiments, the sample 108 is disposed on an optical inspection stage 110 during inspection by the optical inspection tool 102. The optical inspection tool 102 may direct an illumination beam 112 to the sample 108 and collect sample light 114 reflected by the sample 108. The reflected sample light 114 may be used to determine candidate defects on the sample 108 that should be inspected by the multi-column inspection tool 104.

The multi-column inspection tool 104 may be configured to perform a second scan of the sample 108 (e.g., a second phase of hybrid inspection) and any subsequent scans of the sample 108. In embodiments, the sample 108 is disposed on a translation stage 116 during inspection by the multi-column inspection tool 104. The translation stage 116 may include one or more actuators to move in one or more directions, including X, Y, Z, tilt, and rotational directions. These actuators may impart both coarse and fine grade movements and are driven by one or more screw drive and stepper motors, linear drives with feedback position, band actuator and stepper motors, magnetic fields, or the like. Coarse movements may be implemented by the translation stage 116, while fine movements may be implemented by the columns 106. The one or more actuators may implement roller bearings, air bearings, sliding plastic bearings, flexure suspension or magnetic field suspension, or the like. In embodiments, the multi-column inspection tool 104 may alternatively or additionally move in one more directions, including X, Y, Z, tilt, and/or rotational directions.

Additionally, the translation stage 116 may be configured as a swathing stage or a step-and-settle stage. In embodiments, the translation stage 116 performs swathing movements and step-and-settle movements. In embodiments, the translation stage 116 is used with the multi-column inspection tool 104, while the optical inspection tool 102 utilizes an additional stage (e.g., the sample 108 is moved between the optical inspection tool 102 and the multi-column inspection tool 104). The translation stage 116 may be configured to operate with both the optical inspection tool 102 and the multi-column inspection tool 104. For example, the optical inspection tool 102 and the multi-column inspection tool 104 may share a common translation stage 116.

The multi-column inspection tool 104 may direct an electron beam 118 to the sample 108 and collect scattered electrons 120. The scattered electrons may be used to determine which of the candidate defects identified by the optical inspection tool 102 are defects of interest.

It should be noted that the optical inspection tool 102 and the multi-column inspection tool 104 may be configured as separate tools and the sample 108 may need to be transferred between the optical inspection tool 102 and the multi-column inspection tool 104 to complete both phases of hybrid inspection. Additionally, the optical inspection stage 110 and the translation stage 116 may be configured as separate stages or they may be a common stage.

In embodiments, the hybrid inspection system 100 includes a controller 122 communicatively coupled to the optical inspection tool 102, the multi-column inspection tool 104, and/or the translation stage 116. In embodiments, the controller 122 includes one or more processors 124. For example, the one or more processors 124 may be configured to execute a set of program instructions maintained in a memory 126, or memory device. The controller 122 may be located in a remote housing (e.g., on a server) or in one or more of the optical inspection tool 102 and the multi-column inspection tool 104.

In embodiments, the scan by the multi-column inspection tool 104 occurs after the scan by the optical inspection tool 102. This may allow the one or more processors 124 of the controller 122 to generate a step-and-settle sampling plan to be executed by the multi-column inspection tool 104 and the translation stage 116.

The step-and-settle sampling plan may be generated in response to candidate defects identified in the first phase of inspection by the optical inspection tool 102. The step-and-settle sampling plan may direct the multi-column inspection tool 104 to inspect a selected number of candidate defects within a selected time. Additionally, the step-and-settle sampling plan may cause each column 106 or a selected number of columns 106 to inspect a defect of interest after each step. The step-and-settle sampling plan may also dictate whether the step size remains constant throughout inspection or varies during inspection. The processors 124 may also take into account additional considerations, such as time to scan the sample 108, sample geometry, candidate defect density, or constraints of the translation stage 116.

The step-and-settle may be generated by the one or more processors 124 of the controller 122 whether the controller 122 is located at a distance from the optical inspection tool 102 and/or the multi-column inspection tool 104 (e.g., on a server) or the controller 122 is located within one or more of the optical inspection tool 102 or the multi-column inspection tool 104.

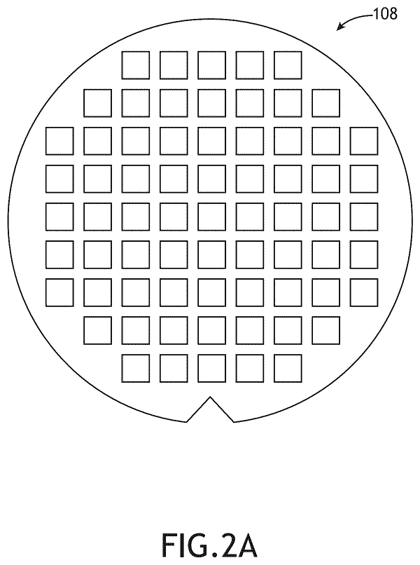

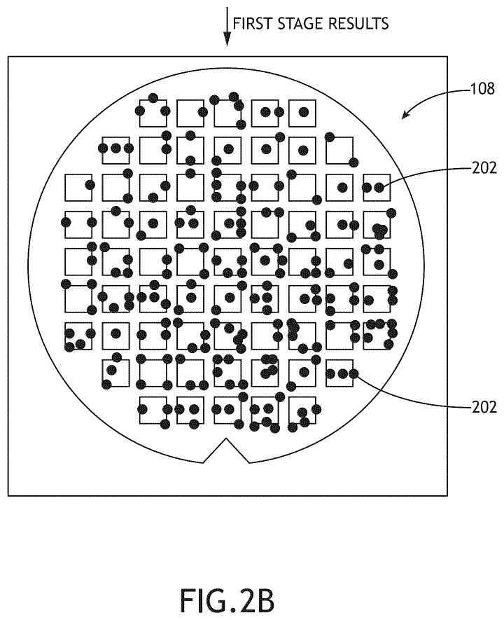

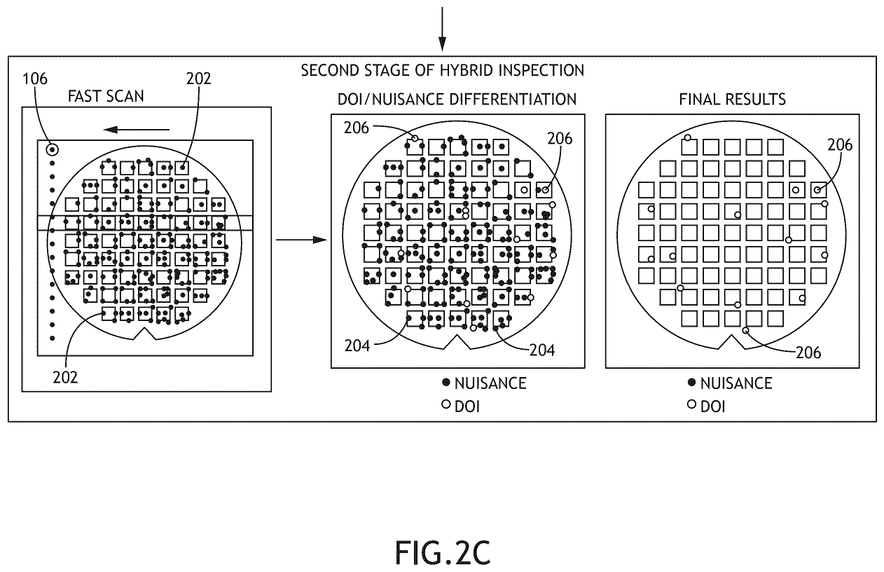

FIG. 2A illustrates a first phase of hybrid inspection, in accordance with one or more embodiments of the present disclosure. For example, FIG. 2A illustrates a sample 108 (e.g., a wafer) that may be inspected during a hybrid inspection process. The first phase of hybrid inspection may include an optical inspection (e.g., an optical scan) by the optical inspection tool 102.

FIG. 2B illustrates results of the first phase of hybrid inspection, in accordance with one or more embodiments of the present disclosure. The first phase of hybrid inspection may uncover any number of candidate defects 202. The number of candidate defects 202 may be in the millions or tens of millions for a 150-millimeter (mm) sample 108. Each candidate defect 202 may either be categorized as a nuisance 204 or defect of interest 206. A nuisance 204 is a defect that may not affect the overall performance of the finished device, while a defect of interest 206 is likely to affect the performance of the finished device.

After results from the first phase scan have been collected, an optimization process may occur (e.g., by the one or more processors 124). The results of the first phase of the scan may be used to optimize the second phase of scanning (e.g., optimizing a step-and-settle sampling plan) the sample 108 (e.g., inspection of the sample by the multi-column inspection tool 104). For example, the optimization process may dictate step size or the scan locations on the sample 108.

Additionally, the optimization process may be based on considerations such as time (e.g., time permitted to scan a sample 108), sample geometry, or translation stage constraints. For example, the translation stage constraints may include how fast the translation stage 116 can move from one location to the next, or the time required for the translation stage 116 settle after moving to a new location.

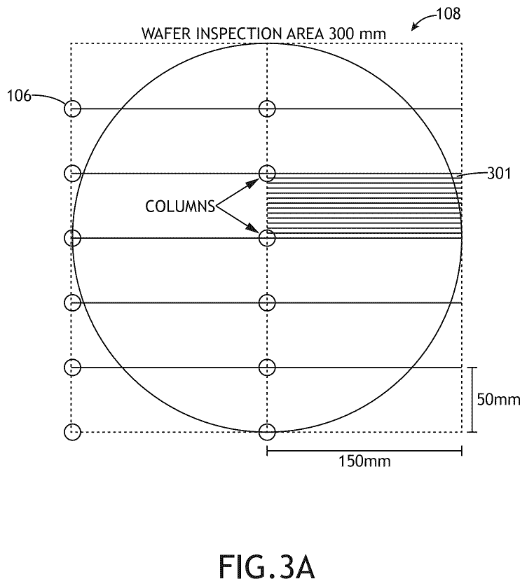

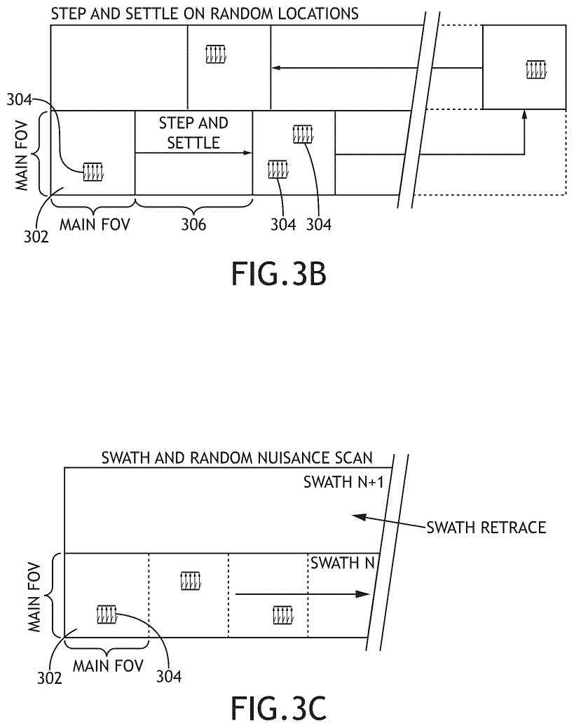

FIG. 2C illustrates a second phase of hybrid inspection and associated results, in accordance with one or more embodiments of the present disclosure. After the first phase of hybrid inspection by the optical inspection tool 102, the sample 108 may be rescanned with a multi-column inspection tool 104. For example, in FIG. 2C, the sample 108 is scanned by a 1×15 array of columns 106. In embodiments, the columns 106 are microelectromechanical system (MEMS) based electron beam columns. However, it should be noted that any suitable electron-based column may be used for the second phase of scanning. Additionally, any array of columns 106 may be used and may have any number of rows and columns may be used. It is contemplated that an array with two sets of columns 106 may be advantageous for scanning the sample 108. For example, a 2×6 array of columns 106 may be used. While the use of a one-dimensional (1D) array of columns 106 (e.g., 1×15 array of columns 106 in FIG. 2C) is possible, it is contemplated that a two-dimensional (2D) array of columns 106, such as the one illustrated in FIG. 3A, may provide superior benefits. The 2D array of columns 106 may be easier to manufacture, and therefore, reduce the cost of the multi-column inspection tool 104, and therefore, the hybrid inspection system 100.

The sample 108 may be moved (e.g., by the translation stage 116) in a step-and-settle manner relative to the columns 106. In this way, the translation stage 116 may move the sample 108 and come to a complete stop before being scanned by any of the columns 106.

Scanning of the sample by the columns 106 of the multi-column inspection tool 104 may allow for the hybrid inspection system 100 to characterize the candidate defects 202 as nuisances 204 or defects of interest 206. For example, it can be seen that only a small number of candidate defects 202 identified by the optical inspection tool 102 in the first phase of scanning are actually defects of interest 206. Defects of interest 206 may correspond to sites on the sample 108 that adversely impact operation of any devices that the sample 108 may be used with.

FIG. 3A illustrates an array of columns 106 in the multi-column inspection tool 104, in accordance with one or more embodiments of the present disclosure.

The columns 106 are organized as a 2×6 array configured to cover a 300 mm by 300 mm sample 108. Therefore, each column 106 may be required to cover an area of 150 mm by 50 mm. Each 150 mm by 50 mm area may be covered by either a step-and-settle approach (e.g., as shown in FIG. 3B) or a swathing approach (e.g., as shown in FIG. 3C).

Each column 106 may follow a path 301 on the sample 108. For example, the sample 108 may be moved horizontally such that the column 106 may inspect the sample 108 at numerous locations across the width of the sample 108. The sample 108 may then be moved a distance perpendicular to the horizontal path 301 and additional inspection may occur following the horizontal path 301 in the opposite direction. This pattern may continue until an entire area is scanned by the column 106.

Referring now to FIGS. 3B and 3C, a step-and-settle approach and a swathing approach are illustrated. While it is contemplated that a step-and-settle approach may be beneficial because of the time required to scan a sample 108 and the cost of equipment to implement the step-and-settle approach, a hybrid inspection system 100 may be capable of performing both a step-and-settle approach and a swathing approach.

FIG. 3B illustrates a schematic view of step-and-settle sampling plan for a single column 106, in accordance with one or more embodiments of the present disclosure.

The translation stage 116 may be configured to move the sample 108 by a step size 306. It should be noted that the step size 306 may be constant. For example, the step size 306 between a first main field of view and a second main field of view may be the same the step size 306 between every other two main fields of view. The step size 306 may also vary. For example, the step size 306 between a first main field of view and a second main field of view may be different that the step size 306 between any other two main fields of view. The step size 306 between main fields of view 302 may be determined by optimizing the step-and-settle sampling plan after the optical inspection tool 102 determines candidate defects 202 on the sample 108.

The step size 306 may be selected based on a density of the candidate defects 202 to provide at least one of the candidate defects 202 within each of the two or more measurement regions 304 for each step size 306 with a selected probability. The step size 306 may also be selected based on a density of the candidate defects 202 to provide images of a selected percentage of the candidate defects 202.

After scanning with the optical inspection tool 102, it may be desirable to have at least one measurement region 304 in each main field of view 302 for each column 106. This may be desirable as each column 106 may be physically fixed within the multi-column inspection tool 104. Therefore, the step-and-settle operation of the translation stage 116 may get the column 106 in an approximate location to cover the candidate defect with the main field scan, but the column 106 may get to a more precise location by utilizing a static deflection correction and a sub field scan to cover the candidate defect 202. If there are additional measurement regions 304 within a main field of view 302, the columns 106 may rescan the sample 108 to image a second measurement region 304 within the main field of view 302.

FIG. 3C illustrates a schematic view of swathing sampling plan for a single column 106, in accordance with one or more embodiments of the present disclosure.

In a swathing sampling plan, the translation stage 116 may be constantly in motion in order to scan the sample 108. Additionally, the translation stage 116 may remain fixed while the multi-column inspection tool 104 is in constant motion to scan the sample 108. Additionally, the translation stage 116 and the multi-column inspection tool 104 may both be movable. The motion may occur in any direction or combination of directions.

For example, during a swathing scan, the columns 106 may continuously pass over main fields of view 302. Each of these main fields of view 302 may include one or more measurement regions 304.

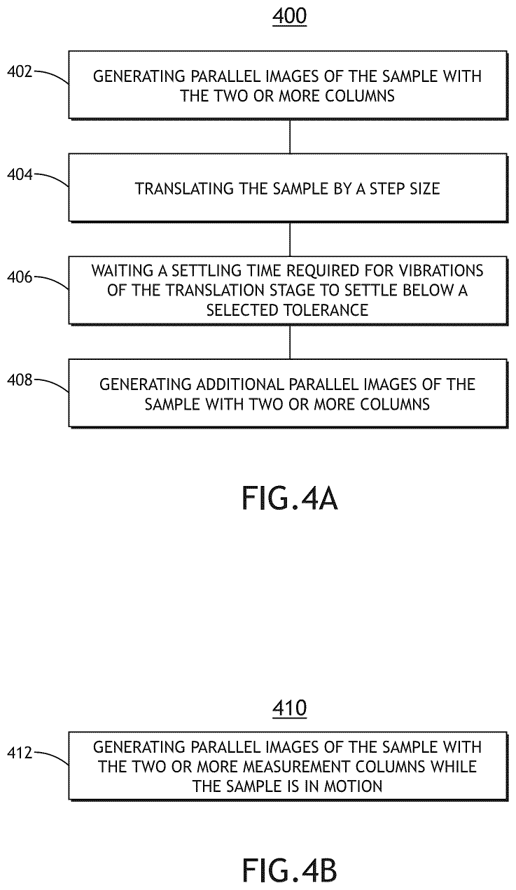

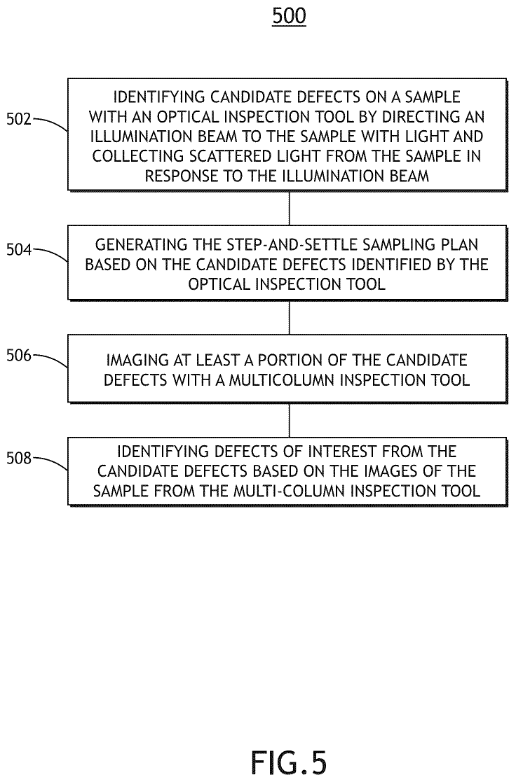

Referring now to FIGS. 4A-5, steps performed by the hybrid inspection system 100 are described in greater detail. FIGS. 4A and 4B illustrate steps that may be taken during a step-and-settle sampling approach and a swathing sampling approach, respectively. FIG. 5 illustrates steps that may be taken for sample inspection with a hybrid inspection system. It should be noted that the steps discussed in FIGS. 4A and 4B may be performed as part of, or in conjunction with, the steps discussed in FIG. 5.

FIG. 4A illustrates a flow diagram illustrating a step-and-settle sampling plan 400, in accordance with one or more embodiments of the present disclosure. The step-and-settle sampling plan 400 may be performed iteratively.

In embodiments, the step-and-settle sampling plan 400 includes a step 402 of generating parallel images of the sample 108 with two or more columns 106. For example, each column 106 of the multi-column inspection tool 104 may generate an image for a measurement region 304 within a main field of view 302 on the sample 108. Each column 106 may image measurement regions 304 within multiple main fields of view 302 on the sample 108.

In embodiments, the step-and-settle sampling plan 400 includes a step 404 of translating the sample 108 by a step size 306. Translation of the sample 108 may occur in both the x-and y-directions to achieve a complete inspection of the sample 108. The step size 306 between two main fields of view 302 may be determined by an optimization process for inspection by the multi-column inspection tool 104 after the conclusion of inspection by the optical inspection tool 102. The step size 306 may or may not be consistent throughout the inspection of an entire sample 108. Additionally, the step size 306 may be configured such that main fields of view 302 overlap, are directly next to each other, or have some amount of space in between them.

In embodiments, the step-and-settle sampling plan 400 includes a step 406 of waiting a settling time required for vibrations for the translation stage 116 to settle below a selected tolerance. For example, it may be desirable for the translation stage 116 to be completely still when imaging the sample 108. However, that need not always occur, and some level of vibration may still allow the multi-column inspection tool 104 to obtain sufficiently clear images of the sample 108 to make determinations on whether the candidate defects 202 are nuisances 204 or defects of interest 206.

In embodiments, the step-and-settle sampling plan 400 includes a step 408 of generating additional parallel images of the sample with two or more columns 106. For example, additionally parallel images may be taken for measurement regions 304 within the same main field of view 302 or for measurement regions 304 within a different main field of view 302. Additionally, images may be taken on the multi-column inspection tool's 104 second scan of the sample 108.

FIG. 4B illustrates a flow diagram illustrating a swathing sampling plan 410, in accordance with one or more embodiments of the present disclosure.

In embodiments, the swathing sampling plan 410 includes a step 412 of generating parallel images of the sample 108 with the two or more measurement columns 106 while the sample 108 is in motion.

A hybrid inspection system 100 may be capable of implementing both a step-and-settle sampling plan 400 and a swathing sampling plan 410. The step-and-settle sampling plan 400 may be selected when a density of the candidate defects 202 is below a threshold and the swathing sampling plan 410 may be selected when the density of the candidate defects 202 is above the threshold. For example, this threshold may be based on time, where if the amount of candidate defects 202 would likely result in a scan of the sample 108 by a step-and-settle sampling plan 400 taking too long, the swathing sampling plan 410 may be selected.

FIG. 5 illustrates a flow diagram illustrating a method 500 for hybrid inspection, in accordance with one or more embodiments of the present disclosure. Applicant notes that the embodiments and enabling technologies described previously herein in the context of the hybrid inspection system 100 should be interpreted to extend to method 500. It is further noted, however, that the method 500 is not limited to the architecture of the hybrid inspection system 100.

In embodiments, the method 500 includes a step 502 of identifying candidate defects on a sample with an optical inspection tool by directing an illumination beam to the sample with light and collecting scattered light from the sample in response to the illumination beam. This may be the first phase of inspecting the sample and generate a very large amount of candidate defects. The candidate defects may include both nuisances and defects of interest.

In embodiments, the method 500 includes a step 504 of generating the step-and-settle sampling plan based on the candidate defects identified by the optical inspection tool. For example, the step-and-settle sampling plan may determine whether or not the step size is constant or variable throughout the inspection process. Additionally, the step-and-settle sampling plan may be generated so a selected percentage (e.g., 90%) of candidate defects are characterized within a selected time (e.g., one hour). The step-and-settle sampling plan may also be generated so a selected number of columns inspect a measurement region within a main field of view. For example, the selected number of columns may be 11 out of 12 columns 106 in a 2×6 array of columns. The step-and-settle sampling plan may also be based on at least one of time, sample geometry, candidate defect density, or translation stage constraints.

In embodiments, the method 500 includes a step 506 of imaging at least a portion of the candidate defects with a multi-column inspection tool. The multi-column inspection tool may image a sample that is moved around in a step-and-settle manner in order to image a sufficient amount of the candidate defects, within a prescribed time.

In embodiments, the method 500 includes a step 508 of identifying defects of interest from the candidate defects based on the images of the sample from the multi-column inspection tool. The multi-column inspection tool may have a higher resolution than the optical inspection tool. Therefore, the multi-column inspection tool may be able to characterize the candidate defects, while the optical inspection tool may not.

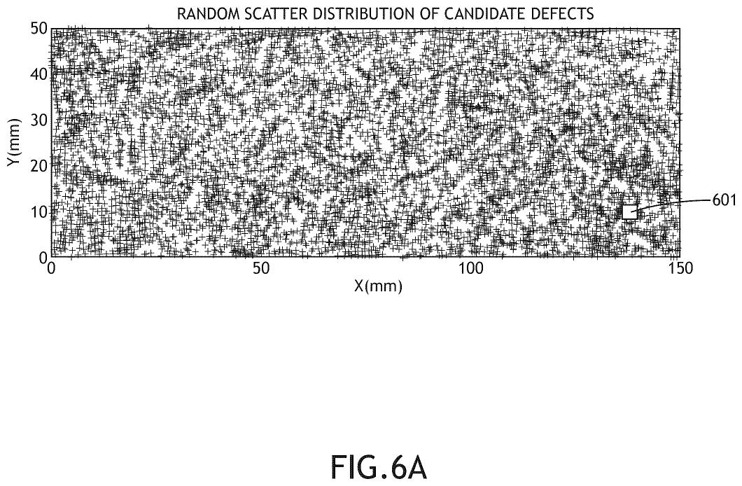

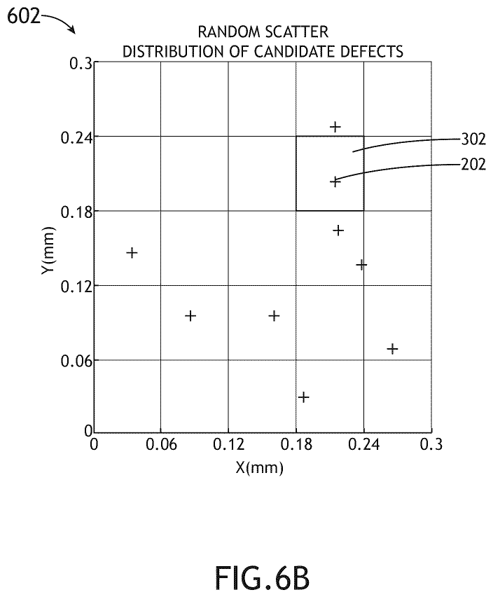

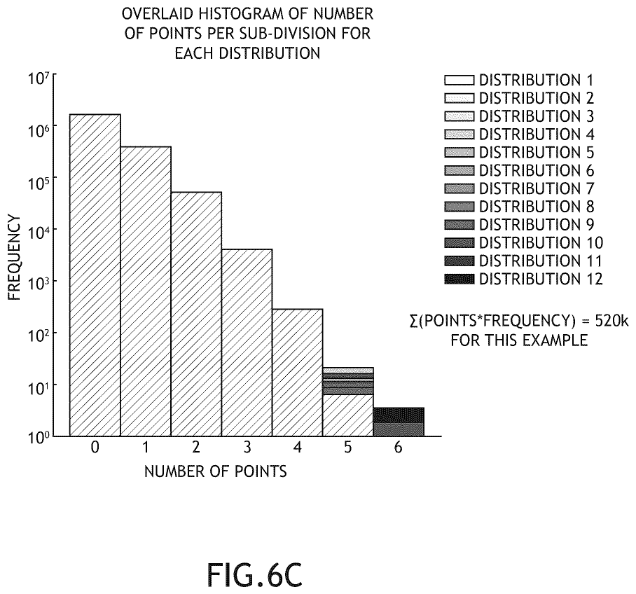

Referring now to FIGS. 6A-6C, the results of imaging by the optical inspection tool 102 are illustrated. In particular, a 150 mm×50 mm area (e.g., the area scanned by a column 106) is shown, along with a subdivision of that area. Additionally, a plot illustrating the distribution of points is included.

FIG. 6A illustrates a plot illustrating a random uniform distribution of candidate defects 202, in accordance with one or more embodiments of the present disclosure. Represented in FIG. 6A is a 150 mm×50 mm area of a sample 108, which is an area of a sample 108 that may be scanned by a single column 106 of the multi-column inspection tool 104. The plot includes 520,000 random points, which corresponds to an average spacing between points of 0.12 mm. Additionally, FIG. 6A includes a subdivision 602, which corresponds to FIG. 6B. It should be noted that while the subdivision 602 may not include any candidate defects in FIG. 6A, that is for illustrative purposes only, as FIG. 6B shows the subdivision 602 with more detail.

FIG. 6B illustrates a subdivision 602 of the plot in FIG. 6A, in accordance with one or more embodiments of the present disclosure. A 0.3 mm×0.3 mm area is represented in FIG. 6B with a smaller area of 0.06 mm×0.06 mm called out. This smaller area may represent the size of a main field of view 302. In this example, the area includes a single point, which represents a candidate defect 202. It is noted that while the optical inspection tool 102 scanned the entire sample, and therefore the subdivision 602 includes a grid of 0.06 mm×0.06 mm main fields of view 302, the step-and-settle sampling plan 400 may not ultimately cause the multi-column inspection tool 104 to inspect each main field of view 302 in the subdivision.

FIG. 6C illustrates a chart showing the number of points in each subdivision, in accordance with one or more embodiments of the present disclosure. This histogram shows a distribution of all main fields of view 302 and the associated number of defects of interest 206 found in each main field of view 302.

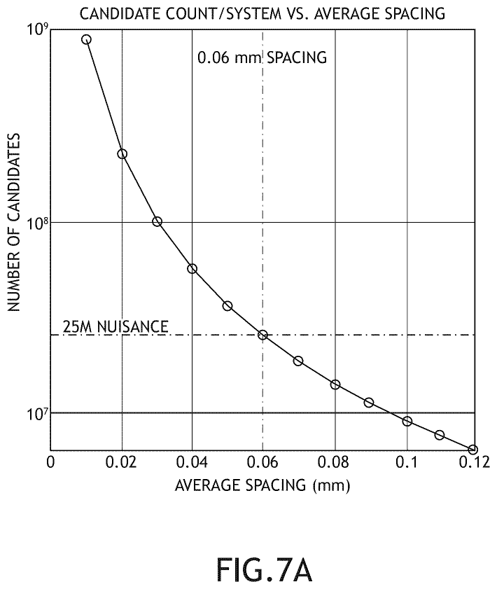

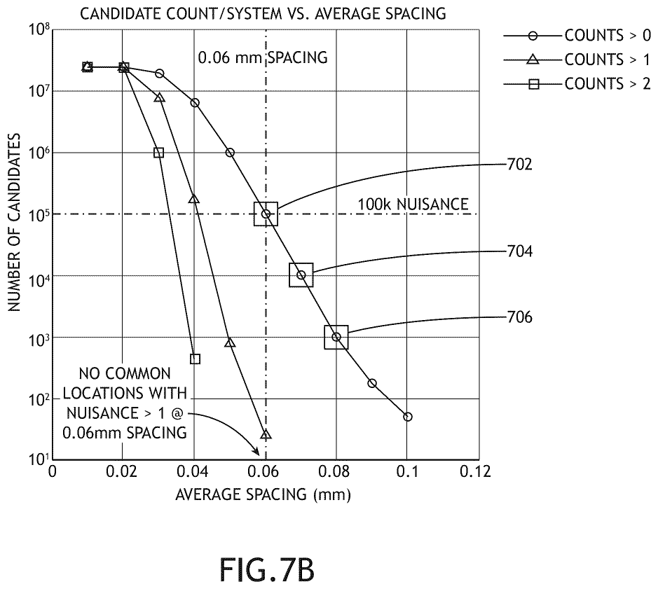

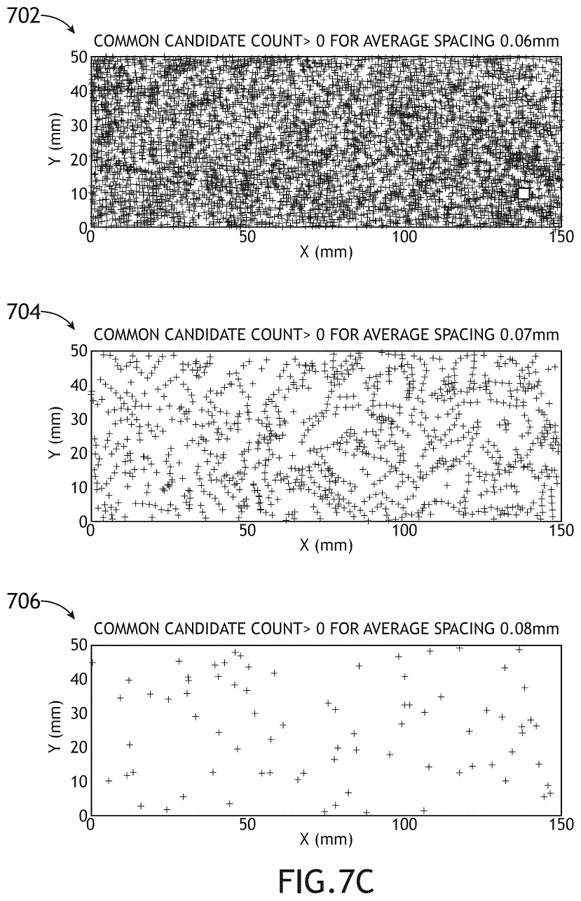

Referring now to FIGS. 7A-7C, considerations regarding selecting an aggressiveness for the optical inspection tool 102 is discussed.

FIG. 7A illustrates a plot of candidate defects 202 for a scan with the optical inspection tool 102, in accordance with one or more embodiments of the present disclosure. For example, in FIG. 7A, it is shown as the number of candidate defect 202 increases, the average spacing decreases. The decrease in the spacing may result in a more robust inspection. However, the increase in the number of candidate defects 202 may result in a prohibitive time requirement to inspect all sites. Therefore, a spacing may be selected that provides sufficient inspection, while also taking time into account.

FIG. 7B illustrates a plot of common candidates between columns 106 of the multi-column inspection tool 104. In FIG. 7B, it can be seen that the number of areas with common candidates decreases as spacing increases. Additionally, as the number of common candidates desired increases, the average spacing between the candidates must decrease to achieve the same number of common candidates. Therefore, if it is desired that each column 106 share one common candidate, the spacing between candidates may be greater than if two common candidates were desired.

Additionally, FIG. 7B includes points 702, 704, and 706 on the graph for common candidates greater than zero at spacings of 0.06 mm, 0.07 mm, and 0.08 mm, respectively.

FIG. 7C illustrates plots of common candidate placement for various spacings, in accordance with one or more embodiments of the present disclosure. FIG. 7C corresponds to called out points 702, 704, and 706 on FIG. 7B. FIG. 7C illustrates the effect of increasing spacing on common candidate distribution and count. As spacing goes up, the number of common candidates goes down and they become more spread out.

This observation may be important for implementing the systems and methods described herein, as too dense of a spread of common candidates may result in the step-and-settle sampling plan taking too long to reach completion. Additionally, too few common candidates may result in unsatisfactory inspection of the sample 108.

For additional clarification, an example of considerations related to FIGS. 7A-7C is discussed below. An optical inspection tool with an aggressive enough threshold netting at least 25 million candidate defects 202, which would translate to approximately 100,000 common candidate sites for the multi-column inspection tool 104, or approximately 8,300 per column 106, with an average spacing of 0.06 mm between candidate defects. At 0.1 second step and settle times, based on the state of the art, the multi-column inspection tool 104 could cover the entire wafer (8,300 step and settle moves) in about 15 minutes per wafer. The image acquisition time (e.g., the scan) is generally 1 millisecond or less and is a much smaller fraction of this time for a small measurement region 304 covering approximately 0.5-1 micrometers of the candidate site.

The number of candidate sites could be increased by approximately a factor of 4 to increase the number of sampled sites to 400,000 per hour, which would result in approximately 33,200 sites per column 106 in approximately one hour. This approach is also scalable to the number of columns in the multi-column inspection tool 104.

Referring again to FIG. 1, additional embodiments of the present disclosure are discussed.

The one or more processors 124 of a controller 122 may include any processor or processing element known in the art. For the purposes of the present disclosure, the term “processor” or “processing element” may be broadly defined to encompass any device having one or more processing or logic elements (e.g., one or more micro-processor devices, one or more application specific integrated circuit (ASIC) devices, one or more field programmable gate arrays (FPGAs), or one or more digital signal processors (DSPs)). In this sense, the one or more processors 124 may include any device configured to execute algorithms and/or instructions (e.g., program instructions stored in memory). In embodiments, the one or more processors 124 may be embodied as a desktop computer, mainframe computer system, workstation, image computer, parallel processor, networked computer, or any other computer system configured to execute a program configured to operate or operate in conjunction with the hybrid inspection system 100, as described throughout the present disclosure. Moreover, different subsystems of the hybrid inspection system 100 may include a processor or logic elements suitable for carrying out at least a portion of the steps described in the present disclosure. Therefore, the above description should not be interpreted as a limitation on the embodiments of the present disclosure but merely as an illustration. Further, the steps described throughout the present disclosure may be carried out by a single controller or, alternatively, multiple controllers. Additionally, the controller 122 may include one or more controllers housed in a common housing or within multiple housings. In this way, any controller or combination of controllers may be separately packaged as a module suitable for integration into the hybrid inspection system 100.

The controller 122 may be located in a common area as the hybrid inspection system 100 and physically connected (e.g., wired) to the optical inspection tool 102, the multi-column inspection tool 104, and/or the translation stage 116. The controller 122 may be located in a common area as the hybrid inspection system 100 and communicatively connected (e.g., over wireless internet) to the optical inspection tool 102, the multi-column inspection tool 104, and/or the translation stage 116. The controller 122 may be located in a different area (e.g., on a server) as the hybrid inspection system 100 and communicatively connected (e.g., over wireless internet) to the optical inspection tool 102, the multi-column inspection tool 104, and/or the translation stage 116.

The memory 126 may include any storage medium known in the art suitable for storing program instructions executable by the associated one or more processors 124. For example, the memory 126 may include a non-transitory memory medium. By way of another example, the memory 126 may include, but is not limited to, a read-only memory (ROM), a random-access memory (RAM), a magnetic or optical memory device (e.g., disk), a magnetic tape, a solid-state drive, and the like. It is further noted that the memory 126 may be housed in a common controller housing with the one or more processors 124. In some embodiments, the memory 126 may be located remotely with respect to the physical location of the one or more processors 124 and the controller 122. For instance, the one or more processors 124 of the controller 122 may access a remote memory (e.g., server), accessible through a network (e.g., internet, intranet, and the like).

In embodiments, the controller 122 is communicatively coupled to the translation stage 116, the multi-column inspection tool 104, and/or the columns 106. The controller 122 may be configured to adjust one or more stage parameters via a control signal transmitted to the translation stage 116. The controller 122 may be configured to vary the sample scanning speed and/or control the scan direction via a control signal transmitted to control circuitry of the translation stage 116, the multi-column inspection tool 104, and/or the columns 106. For example, the controller 122 may be configured to vary the speed and/or control the direction with which the 108 and/or columns 106 are linearly translated (e.g., x-direction or y-direction).

Additionally, a controller 122 with one or more processors 124 may be configured to execute program instructions causing the one or more processors 124 to identify the defects of interest 206 from the candidate defects 202 based on the images of the sample 108. The program instructions may also cause the one or more processors 124 to optimize imaging of the candidate defects 202 by the two or more columns 106 based on at least one of time, sample geometry, or translation stage constraints.

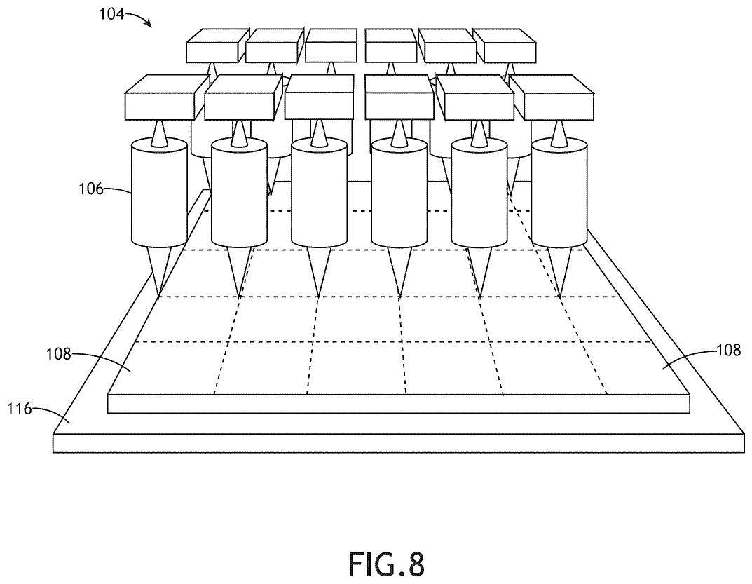

FIG. 8 illustrates a simplified schematic view of a column of a multi-column inspection tool 104, in accordance with one or more embodiments of the present disclosure. Multi-column inspection tools 104 are described in more detail in U.S. Pat. No. 10,777,377, granted on Sep. 15, 2020, which is herein incorporated by reference in its entirety. The multi-column inspection tool 104 may be configured as any suitable multi-column inspection tool 104 known in the art. For example, the multi-column inspection tool 104 may be configured as a multi-column electron beam inspection tool, a multi-column atomic force microscopy inspection tool, a multi-column near-field microwave inspection tool, or a multi-column proximal optical inspection tool.

The multi-column inspection tool 104 may be configured to identify defects of interest 206 on a sample 108. For example, the multi-column inspection tool may differentiate between nuisances 204 and defects of interest 206 in the set of candidate defects 202.

FIG. 8 includes a sample 108 disposed on a translation stage 116. The translation stage 116 may be configured to move the sample 108 relative to the columns 106 of the multi-column inspection tool 104. The translation stage 116 may be configured as part of the hybrid inspection system 100 or specifically as part of the multi-column inspection tool 104.

The translation stage 116 may be configured to secure and position the sample 108 with respect to the two or more columns 106. For example, the translation stage 116 may orient the sample 108 to direct each of the two or more columns 106 to a main field of view 302 on the sample, wherein each main field of view 302 corresponds to a column of the two or more columns 106. Each main field of view 302 may include a measurement region 304, wherein each of the two or more columns 106 directs itself towards the measurement region 304 within the main field of view 302 corresponding to the column 106.The translation stage 116 may be configured to position the sample 108 to allow the two or more columns 106 to image at least a portion of the candidate defects 202 using a step-and-settle sampling plan (e.g., the step-and-settle sampling plan 400 of FIG. 4).

The columns 106 in FIG. 8 are arranged in a 2×6 array of columns 106. It is contemplated that having columns 106 in an array with two columns of columns 106 may be beneficial when compared to arrays with a single column of columns 106. However, a 2×6 array is only exemplary, and any array of columns 106 may be used for the multi-column inspection tool 104. Each of the two or more columns 106 may simultaneously image two or more measurement regions 304 on the sample 108.

FIG. 9 illustrates a simplified schematic view of an optical inspection tool 102, in accordance with one or more embodiments of the present disclosure. The optical inspection tool 102 may be configured to identify candidate defects 202 on a sample 108 by directing an illumination beam 112 to the sample 108 with light and collecting scattered light (e.g., sample light 114) from the sample 108 in response to the illumination beam 112.

In embodiments, the optical inspection tool 102 includes an illumination source 902 configured to generate at least one illumination beam 112. The illumination from the illumination source 902 may include one or more selected wavelengths of light including, but not limited to, ultraviolet (UV) radiation, visible radiation, or infrared (IR) radiation. For example, a illumination pathway 904 may include one or more apertures at an illumination pupil plane to divide illumination from the illumination source 902 into one or more illumination beams 112 or illumination lobes. In this regard, the optical inspection tool 102 may provide dipole illumination, quadrature illumination, or the like. Further, the spatial profile of the one or more illumination beams 112 on the sample 108 may be controlled by a field-plane stop to have any selected spatial profile.

The illumination source 902 may include any type of illumination source suitable for providing at least one illumination beam 112. In some embodiments, the illumination source 902 is a laser source. For example, the illumination source 902 may include, but is not limited to, one or more narrowband laser sources, a broadband laser source, a supercontinuum laser source, a white light laser source, or the like. In some embodiments, the illumination source 902 includes a laser-sustained plasma (LSP) source. For example, the illumination source 902 may include, but is not limited to, a LSP lamp, a LSP bulb, or a LSP chamber suitable for containing one or more elements that, when excited by a laser source into a plasma state, may emit broadband illumination. In some embodiments, the illumination source 902 includes a lamp source. For example, the illumination source 902 may include, but is not limited to, an arc lamp, a discharge lamp, an electrode-less lamp, or the like.

In embodiments, the optical inspection tool 102 directs the one or more illumination beams 112 to the sample 108 via an illumination pathway 904. The illumination pathway 904 may include one or more optical components suitable for modifying and/or conditioning the one or more illumination beams 112 as well as directing the one or more illumination beams 112 to the sample 108. In some embodiments, the illumination pathway 904 includes one or more illumination-pathway lenses 906 (e.g., to collimate the one or more illumination beams 112, to relay pupil and/or field planes, or the like). In embodiments, the illumination pathway 904 includes one or more illumination-pathway optics 908 to shape or otherwise control the one or more illumination beams 112. For example, the illumination-pathway optics 908 may include, but are not limited to, one or more polarizers, one or more phase-control optics (e.g., waveplates), one or more field stops, one or more pupil stops, one or more one or more filters (e.g., spatial and/or spectral filters), one or more beam splitters, one or more diffusers, one or more homogenizers, one or more apodizers, one or more beam shapers, or one or more mirrors (e.g., static mirrors, translatable mirrors, scanning mirrors, or the like).

In embodiments, the optical inspection tool 102 includes an objective lens 910 to focus the one or more illumination beams 112 onto the sample 108.

In embodiments, the sample 108 is disposed on a optical inspection stage 110 suitable for securing the sample 108 and further configured to position the sample 108 with respect to the optical inspection tool 102. It is contemplated that the optical inspection stage 110 may be the same or different as the translation stage 116 discussed herein.

In embodiments, the optical inspection tool 102 images the sample 108 onto at least one detector 912 by collecting at zero-order or nonzero-order diffraction through a collection pathway 914. For example, the collection pathway 914 may include optics to collect sample light 114 and form an image on the detector 912. The collection pathway 914 may include one or more optical elements suitable for modifying and/or conditioning the sample light 114 from the sample 108. In some embodiments, the collection pathway 914 includes one or more collection-pathway lenses 916 (e.g., to collimate the sample light 114, to relay pupil and/or field planes, or the like), which may include, but is not required to include, the objective lens 910. In some embodiments, the collection pathway 914 includes one or more collection-pathway optics 918 to shape or otherwise control the sample light 114. For example, the collection-pathway optics 918 may include, but are not limited to, one or more polarizers, one or more phase-control optics (e.g., waveplates), one or more field stops, one or more pupil stops, one or more filters, one or more beam splitters, one or more diffusers, one or more homogenizers, one or more apodizers, one or more beam shapers, or one or more mirrors (e.g., static mirrors, translatable mirrors, scanning mirrors, or the like).

The detector 912 may be placed at field plane conjugate to the sample 108. Further, the detector 912 may generally include any type of sensor suitable for imaging the sample 108. In some embodiments, the detector 912 is suitable for characterizing a static sample such as, but not limited to, a charge-coupled device (CCD) or a complementary metal-oxide semiconductor (CMOS) device. In this regard, the detector 912 may generate a two-dimensional image in a single measurement. In some embodiments, the detector 912 is suitable for characterizing a moving sample (e.g., a scanned sample). In this regard, the optical inspection tool 102 may operate in a scanning mode in which the sample 108 is scanned with respect to a measurement field during a measurement. For example, the detector 912 may include a 2D pixel array with a capture time and/or a refresh rate sufficient to capture one or more images during a scan within selected image tolerances (e.g., image blur, contrast, sharpness, or the like). By way of another example, the detector 912 may include a line-scan detector to continuously generate an image one line of pixels at a time. By way of another example, the detector 912 may include a time-delay integration (TDI) detector.

The illumination pathway 904 and the collection pathway 914 of the optical inspection tool 102 may be oriented in a wide range of configurations. For example, as illustrated in FIG. 9, the optical inspection tool 102 may include a beamsplitter 920 oriented such that a common objective lens 910 may simultaneously direct the one or more illumination beams 112 to the sample 108 and collect light from the sample 108. For example, the illumination pathway 904 and the collection pathway 914 may contain non-overlapping optical paths and/or separate optical components.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected” or “coupled” to each other to achieve the desired functionality, and any two components capable of being so associated can also be viewed as being “couplable” to each other to achieve the desired functionality. Specific examples of couplable include but are not limited to physically interactable and/or physically interacting components and/or wirelessly interactable and/or wirelessly interacting components and/or logically interactable and/or logically interacting components.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed is:

1. A hybrid inspection system comprising:
an optical inspection tool configured to identify candidate defects on a sample by directing an illumination beam to the sample with light and collecting scattered light from the sample in response to the illumination beam;
a multi-column inspection tool to identify defects of interest from the candidate defects, wherein the multi-column inspection tool comprises:
two or more columns to simultaneously image two or more measurement regions on the sample;
a translation stage configured to secure and position the sample with respect to the two or more columns, wherein the translation stage is configured to position the sample to allow the two or more columns to image at least a portion of the candidate defects using a step-and-settle sampling plan; and
a controller including one or more processors configured to execute program instructions and the step-and-settle sampling plan; wherein the step-and-settle sampling plan comprises iteratively causing at least one of the multi-column inspection tool or the translation stage to:
generate parallel images of the sample with the two or more columns;
translate the sample by a step size with the translation stage;
wait a settling time required for vibrations of the translation stage to settle below a selected tolerance; and
generate additional parallel images of the sample with two or more columns.

2. The hybrid inspection system of claim 1, wherein the one or more process are further configured to generate the step-and-settle sampling plan based on the candidate defects identified by the optical inspection tool.

3. The hybrid inspection system of claim 2, wherein generating the step-and-settle sampling plan comprises:
characterizing a selected percentage of the candidate defects within a selected time.

4. The hybrid inspection system of claim 2, wherein generating the step-and-settle sampling plan comprises:
causing a selected number of columns to inspect a measurement region within a main field of view.

5. The hybrid inspection system of claim 2, wherein the step-and-settle plan comprises a constant step size.

6. The hybrid inspection system of claim 2, wherein the step-and-settle plan comprises a variable step size.

7. The hybrid inspection system of claim 2, wherein generating the step-and-settle sampling plan comprises:
determining the step size so each main field of view includes at least one measurement region for each of the two or more columns.

8. The hybrid inspection system of claim 2, wherein generating the step-and-settle sampling plan comprises:
determining the step size using at least one of time, sample geometry, candidate defect density, or translation stage constraints.

9. The hybrid inspection system of claim 1, wherein the program instructions are configured to cause the one or more processors to identify the defects of interest from the candidate defects based on the images of the sample.

10. The hybrid inspection system of claim 1, wherein the translation stage orients the sample to direct each of the two or more columns to a main field of view on the sample, wherein each main field of view corresponds to a column of the two or more columns.

11. The hybrid inspection system of claim 10, wherein each of the main fields of view comprise a measurement region, wherein each of the two or more columns performs a sub field scan of the measurement region within the main field of view corresponding to the column.

12. The hybrid inspection system of claim 1, wherein the two or more columns are configured to rescan the sample to image a second measurement region within a main field of view.

13. The hybrid inspection system of claim 1, wherein the step size is selected based on a density of the candidate defects to provide at least one of the candidate defects within each of the two or more measurement regions for each step size with a selected probability.

14. The hybrid inspection system of claim 1, wherein the step size is selected based on a density of the candidate defects to provide images of a selected percentage of the candidate defects.

15. The hybrid inspection system of claim 1, wherein the multi-column inspection tool is a multi-column electron beam inspection tool.

16. The hybrid inspection system of claim 1, wherein the multi-column inspection tool is a multi-column atomic force microscopy inspection tool.

17. The hybrid inspection system of claim 1, wherein the multi-column inspection tool is a multi-column near-field microwave inspection tool.

18. The hybrid inspection system of claim 1, wherein the multi-column inspection tool is a multi-column proximal optical inspection tool.

19. The hybrid inspection system of claim 1, wherein the defects of interest correspond to sites that adversely impact operation of any devices on the sample.

20. A hybrid inspection method comprising:
identifying candidate defects on a sample with an optical inspection tool configured to identify by directing an illumination beam to the sample with light and collecting scattered light from the sample in response to the illumination beam; and
imaging at least a portion of the candidate defects with a multi-column inspection tool, wherein the multi-column inspection tool comprises:
two or more columns to simultaneously image two or more measurement regions on the sample;
a translation stage configured to secure and position the sample with respect to the two or more columns, wherein the translation stage is configured to position the sample to allow the two or more columns to image at least a portion of the candidate defects using a step-and-settle sampling plan, wherein the step-and-settle sampling plan comprises iteratively:
generating parallel images of the sample with the two or more columns;
translating the sample by a step size;
waiting a settling time required for vibrations of the translation stage to settle below a selected tolerance; and
generating additional parallel images of the sample with two or more columns; and
identifying defects of interest from the candidate defects based on the images of the sample from the multi-column inspection tool.

21. The hybrid inspection method of claim 20, further comprising:
generating the step-and-settle sampling plan based on the candidate defects identified by the optical inspection tool.

22. The hybrid inspection method of claim 21, wherein generating the step-and-settle sampling plan comprises:
characterizing a selected percentage of the candidate defects within a selected time.

23. The hybrid inspection method of claim 21, wherein generating the step-and-settle sampling plan comprises:
causing a selected number of columns to inspect a measurement region within a main field of view.

24. The hybrid inspection method of claim 21, wherein the step-and-settle plan comprises a constant step size.

25. The hybrid inspection method of claim 21, wherein the step-and-settle plan comprises a variable step size.

26. The hybrid inspection method of claim 21, wherein generating the step-and-settle sampling plan comprises:
determining the step size so each main field of view includes at least one measurement region for each of the two or more columns.

27. The hybrid inspection method of claim 21, wherein generating the step-and-settle sampling plan comprises:
determining the step size using at least one of time, sample geometry, candidate defect density, or translation stage constraints.

28. The hybrid inspection method of claim 20, wherein a controller including one or more processors executing program instructions identifies the defects of interest from the candidate defects based on the images of the sample.

29. The hybrid inspection method of claim 20, wherein the translation stage orients the sample to direct each of the two or more columns to a main field of view on the sample, wherein each main field of view corresponds to a column of the two or more columns.

30. The hybrid inspection method of claim 29, wherein each of the main fields of view comprise a measurement region, wherein each of the two or more columns performs a sub field scan of the measurement region within the main field of view corresponding to the column.

31. The hybrid inspection method of claim 20, further comprising:
rescanning, with the two or more columns, the sample to image a second measurement region within a main field of view.

32. The hybrid inspection method of claim 20, wherein the step size is selected based on a density of the candidate defects to provide at least one of the candidate defects within each of the two or more measurement regions for each step size with a selected probability.

33. The hybrid inspection method of claim 20, wherein the step size is selected based on a density of the candidate defects to provide images of a selected percentage of the candidate defects.

34. The hybrid inspection method of claim 20, wherein the multi-column inspection tool is a multi-column electron beam inspection tool.

35. The hybrid inspection method of claim 20, wherein the multi-column inspection tool is a multi-column atomic force microscopy inspection tool.

36. The hybrid inspection method of claim 20, wherein the multi-column inspection tool is a multi-column near-field microwave inspection tool.

37. The hybrid inspection method of claim 20, wherein the multi-column inspection tool is a multi-column proximal optical inspection tool.

38. The hybrid inspection method of claim 20, wherein the defects of interest correspond to sites that adversely impact operation of any devices on the sample.

39. A hybrid inspection system comprising:
an optical inspection tool configured to identify candidate defects on a sample by directing an illumination beam to the sample with light and collecting scattered light from the sample in response to the illumination beam;
a multi-column inspection tool to identify defects of interest from the candidate defects, wherein the multi-column inspection tool comprises:
two or more columns to simultaneously image two or more measurement regions on the sample; and
a translation stage configured to secure and position the sample with respect to the two or more columns, wherein the translation stage is configured to position the sample to allow the two or more columns to image at least a portion of the candidate defects using either a step-and-settle sampling plan or a swathing sampling plan; and
a controller including one or more processors configured to execute program instructions and the step-and-settle sampling plan; wherein the step-and-settle sampling plan comprises iteratively causing at least one of the multi-column inspection tool or the translation stage to:
generate parallel images of the sample with the two or more columns;
translate the sample by a step size with the translation stage;
wait a settling time required for vibrations of the translation stage to settle below a selected tolerance; and
generate additional parallel images of the sample with two or more columns; and
wherein the swathing sampling plan comprises generating parallel images of the sample with the two or more measurement columns while the sample is in motion.

40. The hybrid inspection system of claim 39, wherein the one or more process are further configured to generate the step-and-settle sampling plan based on the candidate defects identified by the optical inspection tool.

41. The hybrid inspection system of claim 40, wherein generating the step-and-settle sampling plan comprises:
characterizing a selected percentage of the candidate defects within a selected time.

42. The hybrid inspection system of claim 40, wherein generating the step-and-settle sampling plan comprises:
causing a selected number of columns to inspect a measurement region within a main field of view.

43. The hybrid inspection system of claim 40, wherein the step-and-settle plan comprises a constant step size.

44. The hybrid inspection system of claim 40, wherein the step-and-settle plan comprises a variable step size.

45. The hybrid inspection system of claim 40, wherein generating the step-and-settle sampling plan comprises:
determining the step size so each main field of view includes at least one measurement region for each of the two or more columns.

46. The hybrid inspection system of claim 40, wherein generating the step-and-settle sampling plan comprises:
determining the step size using at least one of time, sample geometry, candidate defect density, or translation stage constraints.

47. The hybrid inspection system of claim 39, further comprising:
a controller including one or more processors configured to execute program instructions causing the one or more processors to identify the defects of interest from the candidate defects based on the images of the sample.

48. The hybrid inspection system of claim 39, wherein the translation stage orients the sample to direct each of the two or more columns to a main field of view on the sample, wherein each main field of view corresponds to a column of the two or more columns.

49. The hybrid inspection system of claim 48, wherein each of the main fields of view comprise a measurement region, wherein each of the two or more columns performs a sub field scan of the measurement region within the main field of view corresponding to the column.

50. The hybrid inspection system of claim 39, wherein the two or more columns are configured to rescan the sample to image a second measurement region within a main field of view.

51. The hybrid inspection system of claim 39, wherein step-and-settle sampling plan is selected when a density of the candidate defects is below a threshold, wherein the swathing sampling plan is selected when the density of the candidate defects is above the threshold.

52. The hybrid inspection system of claim 39, wherein the step size is selected based on the density of the candidate defects to provide at least one of the candidate defects within each of the two or more measurement regions for each step size with a selected probability.

53. The hybrid inspection system of claim 39, wherein the step size is selected based on the density of the candidate defects to provide images of a selected percentage of the candidate defects.

54. The hybrid inspection system of claim 39, wherein the multi-column inspection tool is a multi-column electron beam inspection tool.

55. The hybrid inspection system of claim 39, wherein the multi-column inspection tool is a multi-column atomic force microscopy inspection tool.

56. The hybrid inspection system of claim 39, wherein the multi-column inspection tool is a multi-column near-field microwave inspection tool.

57. The hybrid inspection system of claim 39, wherein the multi-column inspection tool is a multi-column proximal optical inspection tool.

58. The hybrid inspection system of claim 39, wherein the defects of interest correspond to sites that adversely impact operation of any devices on the sample.
